(19) United States
(12) Patent Application Publication
(10) Pub. No.: US 2002/0059005 A1
(43) Pub. Date: May 16, 2002

(54) Method of controlling irrigation systems using smart cards

(76) Inventor: Larry C. Sarver, Canonsburg, PA (US)

Correspondence Address: WEBB ZIESENHEIM LOGSDON, ORKIN & HANSON P.C., 700 Koppers Building, 436 Seventh Avenue, Pittsburgh, PA, 15219-1818, US

(21) Appl. No.: 09/873,775

(22) Filed: Jun. 4, 2001

Related U.S. Application Data
(60) Provisional application No. 60/208,966, filed on Jun. 2, 2000.

(51) Int. Cl. G05B 19/42

(52) U.S. Cl. 700/86

(57) ABSTRACT

A method of providing process control instructions to an irrigation site using a smart card. Instructions for adjusting equipment of an irrigation system are stored on a smart card at a remote location. The smart card is transported to the irrigation site. The stored instructions are read from the smart card and downloaded to a control computer. The computer adjusts the process conditions for the irrigation system based on the downloaded instructions.

### RELATED APPLICATIONS

This application claims the benefit of U.S. Provisional Application Serial No. 60/208,966 entitled “Method of Controlling Irrigation Systems Using Smart Cards” filed Jun. 2, 2000.

### BACKGROUND OF THE INVENTION

1. Field of the Invention

The present invention relates to the use of smart cards for remotely controlling irrigation systems.

2. Prior Art

Portable transaction cards with processing power, also called “smart cards”, have been developed in the size of conventional plastic credit cards. These smart cards typically include an embedded computer chip having processing power and memory. Smart cards can be embedded with a microcontroller having a microprocessor, card memory including random access memory (RAM), read-only memory (ROM), and a card reader interface. Other features of a microcontroller present on the card may be a clock, control logic power connections, and the like.

Data is stored on a smart card using a card writing terminal and is read via a card reader. While smart cards have been introduced for use as transaction cards, such as electronic purse or stored value cards, these uses are generally for data transfer and not for process control.

Irrigation systems, particularly remotely located irrigation systems, have a need for process control changes, such as application of new irrigation regimes upon a seasonal or environmental change. In addition, monitoring of irrigation systems typically includes tabulating the amount of water dispersed upon the landscape over a period of time. Conventionally, these tasks have been performed manually. In particular, an operator at a remote irrigation location obtains a set of written instructions to adjust the valves and amount of flow in an irrigation system. This requires the irrigation operator to accurately follow the instructions provided and adjust the valves and water flow appropriately. Flow totalizers may be present on irrigation systems to indicate total water usage for a particular landscape or portion thereof. This totalized flow data is noted by hand and returned to a remote location for accounting purposes. Both of these activities (process control changes and data logging) have conventionally been performed by hand. Accordingly, a need remains for a more automated method of controlling irrigation systems and obtaining data on the water flow thereto.

### SUMMARY OF THE INVENTION

This need is met by the method of the present invention of transmitting process control instructions, such as irrigation control instructions, to an irrigation site. The instructions are stored at a remote site on a portable memory card, such as a smart card. The smart card is transported to an irrigation site, and the instructions are read into a smart card reader at the irrigation site. The instructions are downloaded from the smart card reader to a computer for controlling water flow rate, water valve position, and the like in an irrigation system.

The irrigation system may include data loggers, such as a flow totalizer or an environmental sensor. Information from the data logger may be transferred to a computer and uploaded to a smart card writer. The smart card writer stores the information from the data logger onto a smart card. The smart card is transported to a remote site and is read by a smart card reader. The information from the smart card reader is downloaded to a computer at the remote site for analysis at the remote site.

### BRIEF DESCRIPTION OF THE DRAWINGS

FIG. 1 is a block diagram of one use of a smart card according to the present invention; and

FIG. 2 is a block diagram of an alternative use of a smart card according to the present invention.

### DETAILED DESCRIPTION OF THE PREFERRED EMBODIMENTS

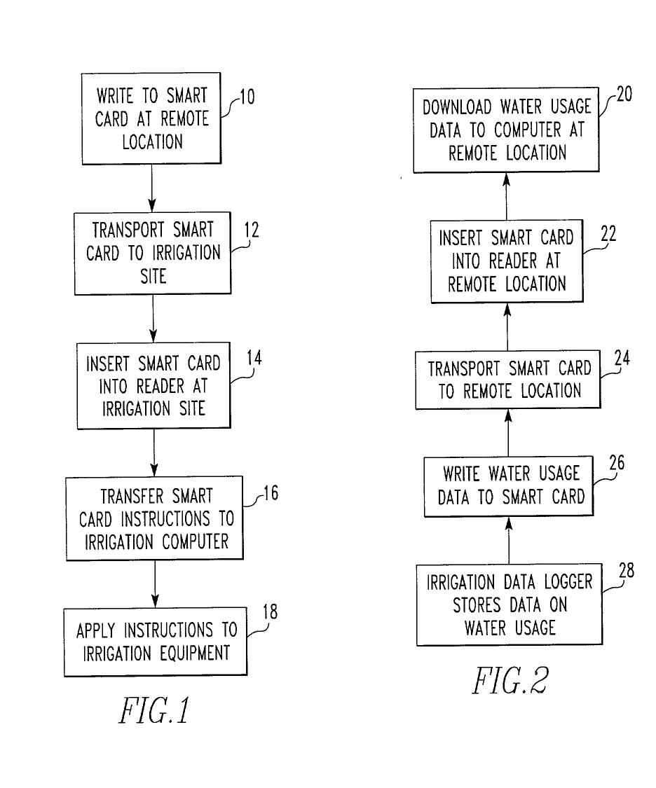

The present invention utilizes smart card technology for controlling irrigation systems. FIG. 1 represents a flow diagram of the method according to the present invention of providing process control instructions from a remote location to a process system, such as an irrigation system. A smart card is issued at a remote location in step 10. In step 10, instructions for altering irrigation systems are written onto the microchip of a portable memory card, such as a smart card. Non-limiting examples of instructions for the irrigation system include a time schedule for a period of time at which certain valves in the irrigation system are opened and closed, flow rates for water lines, and valve positions. In step 12, the smart card is transported to the irrigation site. The transport may occur by hand, via the mail, or any other system for physically transporting the smart card to the irrigation site. Once the smart card reaches the irrigation site, an operator inserts the smart card in step 14 into a smart card reader at the irrigation site. The smart card reader reads the instructions stored in the smart card and the instructions are uploaded in step 16 to an irrigation computer. The smart card may require entry of a security code or a password into the smart card reader to allow reading. The irrigation computer is linked to the control equipment of the irrigation system, such as flow control valves. In step 18, the instructions are provided to the irrigation equipment and the flow changes are made accordingly. A benefit of this method of providing instructions to irrigation equipment from a remote location is that precise instructions for control of each individual valve can be included in the smart card. Once the smart card reaches the irrigation site, an operator need only insert the smart card into a reader at the irrigation site. At that point, the remainder of the process is automated in that the instructions are transferred to the irrigation computer and applied to the irrigation equipment.

After the irrigation equipment has been in use for a period of time, it is desirable to obtain information on the flow of water to the irrigated landscape and information on the environment of the irrigated landscape. Hence, the present invention also includes a method of obtaining data on the irrigation site and transferring the data to a remote location. The remote location for transfer of data may be the same or different from the remote location at which the smart card is read in step 10 of FIG. 1. An irrigation site typically includes meters and other irrigation equipment which are capable of detecting irrigation data on flow rates, total flow, and equipment status (e.g., valve position of open or closed). The irrigation data is queried by a data logger of a computer and is transferred thereto. Additional information useful at an irrigation site is the environmental conditions over a period of time, such as the amount of precipitation, temperature, and wind. Data on such environmental conditions may also be transferred to a computer. In this embodiment depicted in the flow diagram of FIG. 2, an irrigation data logger stores the metering data from the irrigation site in step 20 and, optionally, the environmental conditions at the irrigation site. The irrigation and environmental data is written to a smart card in step 22 and is stored thereon. The smart card is transported to a remote location in step 24 manually, such as by hand or via the mail. Upon arrival at the remote location, the smart card is inserted into a smart card reader at the remote location according to step 26. In step 28, the irrigation and environmental data stored on the smart card is downloaded to a computer at the remote location. In this manner, information on water use and equipment status at a plurality of irrigation sites can be transferred to a single remote location in a cost-effective manner. In addition, new process control instructions can be generated based on the data on water use, equipment status, and environmental conditions of the irrigation site.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

I claim:

1. A method of transmitting process control instructions from a remote site to a site of process control comprising the steps of:
a) storing process control instructions on a portable memory card at one location;
b) transporting the memory card to another location;
c) transferring the process control instructions from the memory card to a memory card reader;
d) transferring the process control instructions from the memory card reader to a computer;
e) storing the process control instructions in the computer of step (d); and
f) operating a process system by the computer of step (d) according to the process control instructions stored in step (e).

2. The method of claim 1 wherein said memory card is a smart card.

3. The method of claim 2 wherein the process control instructions comprise a schedule for delivering water in an irrigation system.

4. The method of claim 3 wherein the process control instructions comprise a schedule for opening a valve on an irrigation water line.

5. The method of claim 3 wherein the process control instructions comprise flow rate for water in an irrigation water line.

6. The method of claim 1 wherein step (c) comprises entering a security code into the memory card reader to allow transfer of the process control instructions to the memory card reader.

7. A method of transmitting irrigation control instructions from a remote site to an irrigation site comprising the steps of:
a) storing irrigation control instructions on a smart card at one location;
b) transporting the smart card to another location;
c) transferring the irrigation control instructions from the smart card to a smart card reader;
d) transferring the irrigation control instructions from the smart card reader to a computer;
e) storing the irrigation control instructions in the computer of step (d); and
f) operating an irrigation system by the computer of step (d) according to the irrigation control instructions stored in step (e).

8. The method of claim 7 wherein the irrigation control instructions comprise a schedule for delivering water in an irrigation system.

9. The method of claim 8 wherein the irrigation control instructions comprise a schedule for opening a valve on an irrigation water line.

10. The method of claim 8 wherein the irrigation control instructions comprise flow rate for water in an irrigation water line.

11. The method of claim 1 wherein step (c) comprises entering a security code into the smart card reader to allow transfer of the irrigation control instructions to the smart card reader.

12. A method of monitoring an irrigation site comprising the steps of.
a) collecting process data from an irrigation system at one location;
b) storing the process data of step (a) on a smart card;
c) transporting the smart card to another location; and
d) transferring the process data stored on the smart card of step (c) to a computer at the other location.

13. The method of claim 12 wherein the process data comprises flow rate, totalized flow, equipment status, or environmental conditions at the irrigation site.

14. The method of claim 13 further comprising a step of adjusting process conditions for the irrigation system based on the process data transferred to the other location.

15. The method of claim 14 wherein said step of adjusting the process conditions comprises:
i) storing irrigation control instructions on a smart card at the remote site;
ii) transporting the smart card to the irrigation site;
iii) transferring the irrigation control instructions from the smart card to a smart card reader;
iv) transferring the irrigation control instructions from the smart card reader to a computer;
v) storing the irrigation control instructions in the computer of step (iv); and
vi) adjusting the irrigation system according to the instructions stored in step (i) in response to the process data collected in step (a).
